(19) United States
(12) Patent Application Publication
(10) Pub. No.: US 2026/0084854 A1
(43) Pub. Date: Mar. 26, 2026

(54) END-OF-LINE BOX PROCESSING ONBOARD AUTONOMOUS MOBILE ROBOTS

(71) Applicant: Ranpak Corp., Concord Township, OH (US)

(72) Inventors: Bruno LESPINASSE, Turku (FI); Saar DAVIDE, Kiryat Ono (IL)

(73) Assignee: Ranpak Corp., Concord Township, OH (US)

(21) Appl. No.: 19/114,217

(22) PCT Filed: Sep. 28, 2023
(86) PCT No.: PCT/US2023/075450

§ 371 Date: Mar. 21, 2025

Related U.S. Application Data
(60) Provisional application No. 63/378,047, filed on Sep. 30, 2022.

(51) Int. Cl. B65B 57/04; B25J 9/16; B65B 43/42

(52) U.S. Cl. CPC B65B 57/04; B25J 9/162; B25J 9/1664; B65B 43/42; B65B 2210/02

(57) ABSTRACT

A packaging system for end-of-line box processing includes two or more end-of-line box processing stations each configured to perform one or more end-of-line processing operations, an autonomous vehicle, and a controller. The box processing stations include a supply of boxes, a product delivery station where objects to be shipped are placed in a box, and a sensor for detecting characteristics of the box and the objects in the box. The autonomous vehicle is configured to autonomously transport the box from the product delivery station to selected ones of the two or more box processing stations. The controller is in communication with the sensor and the autonomous vehicle, and is configured to selectively direct the autonomous vehicle to transport the box from the product delivery station to other selected ones of the two or more box processing stations, based at least in part on information from the sensor.

### FIELD OF THE INVENTION

The present disclosure relates generally to a packaging system for end-of-line box processing, and more particularly, to a packaging system for end-of-line box processing using autonomous mobile robots.

### BACKGROUND

In the process of shipping one or more objects from one location to another, a package may undergo multiple end-of-line processing operations before the package is ready to be shipped. Some exemplary end-of-line processes include forming or erecting a box, packing the box with both the objects to be shipped and optionally a protective packaging material, and closing, lidding or sealing the box. Whether such end-of-line processes are performed manually or performed by automated or semi-automated packaging systems, the box is typically conveyed from an upstream end of a fixed, permanent transport system, such as, for example, a continuous conveyor system, that defines a fixed path for every package as it moves downstream through each of multiple stations where the respective end-of-line processes are performed.

### SUMMARY

The present disclosure describes a packaging system for end-of-line box processing onboard autonomous transport vehicles, such as, for example, autonomous mobile robots in place of a fixed transport system, such as a conveyor. Using autonomous transport devices along with a control system that delivers packaging containers only to selective packaging stations provides several advantages, including more flexibility for worker movement around and within the packaging system, and more flexibility in placement of packaging stations within a packaging area, making reconfigurations easier and reducing the necessity for human decision making between stations. The lack of a need for a fixed path also can speed up the packaging process by delivering containers only to the packaging stations that are required and bypassing packaging stations with packaging operations that are not needed, freeing up space at those stations for containers that need those packaging operations and avoiding delays for containers that do not need those packaging operations from needing to wait for a preceding container to clear a packaging station.

An exemplary packaging system for end-of-line box processing comprises two or more end-of-line box processing stations each configured to perform one or more end-of-line box processing operations, an autonomous vehicle, and a controller. The end-of-line box processing stations include a supply of boxes, a product delivery station where objects to be shipped are placed in a box, and a sensor for detecting characteristics of the box and the objects in the box. The autonomous vehicle is configured to autonomously transport the box from the product delivery station to selected ones of the two or more end-of-line box processing stations. And the controller is in operable communication with the sensor and the autonomous vehicle. The controller is configured to, based, at least in part, on information from the sensor, selectively direct the autonomous vehicle to autonomously transport the box from the product delivery station to other selected ones of the two or more end-of-line box processing stations.

According to one or more embodiments of the packaging system, the autonomous vehicle is an autonomous mobile robot, and the box is onboard the autonomous mobile robot when the at least one of the one or more end-of-line box processing operations is performed on the box.

In one or more embodiments, the sensor is configured to detect at least one characteristic of the box, including at least one of a height dimension, a width dimension, a depth dimension, and a void volume. The at least one detected characteristic may include a nonconformant indicator of the box.

In one or more embodiments, the controller is configured to direct the autonomous vehicle to autonomously transport the box along a route that bypasses at least one of the two or more end-of-line box processing stations.

In one or more embodiments, at least one of the two or more end-of-line box processing stations is automated.

In one or more embodiments, the at least one of the two or more end-of-line box processing stations includes a first end-of-line box processing station and a second end-of-line box processing station disposed remote from the first end-of-line box processing station so that the automated vehicle can be directed to a selected one of the first end-of-line box processing station and the second end-of-line box processing station but not the other one of the first end-of-line box processing station and the second end-of-line box processing station. The first end-of-line box processing station and the second end-of-line box processing station may perform a same end-of-line box processing operation, or the first end-of-line box processing station and the second end-of-line box processing station may perform a different end-of-line box processing operation.

An exemplary end-of-line box processing method comprises the steps of: (a) providing a packaging system having two or more end-of-line box processing stations and one or more autonomous vehicles configured to move a box between selected ones of the two or more end-of-line box processing stations, the end-of-line box processing stations including a product delivery station where objects to be shipped are placed in the box for shipment; (b) loading a box on an automated vehicle to transport the box to selective ones of the two or more end-of-line box processing stations; (c) after the objects to be shipped are placed in the box, scanning the box to detect characteristics of the box and the objects in the box; and (d) directing the automated vehicle to transport the box on a route from the product delivery station to selective ones of the two or more end-of-line box processing stations based, at least in part, on the detected characteristic information.

According to one or more embodiments of the end-of-line box processing method, the method further comprises the step of selectively causing at least one of the one or more end-of-line box processing stations to perform at least one of the one or more end-of-line box processing operations on the box. The box may be onboard the autonomous vehicle when the at least one of the one or more end-of-line box processing operations is performed on the box.

In one or more embodiments, the method further comprises the step of detecting at least one characteristic of the box and updating the route based, at least in part, on the detected characteristic. The detecting step may include identifying at least one detected characteristic that indicates that the box is nonconformant.

In one or more embodiments, the directing step includes instructions to bypass at least one end-of-line box processing station.

In one or more embodiments, the loading step includes erecting a box and placing the box on the autonomous vehicle.

In one or more embodiments, the scanning step includes detecting one or more of a height dimension of the box, a width dimension of the box, a depth dimension of the box, a height dimension of one or more objects in the box, nonconformant characteristics of the box, and a void volume of the box. The scanning step may be repeated after the box is transported to at least one end-of-line box processing station.

In one or more embodiments, the method may further comprise the step of transporting the box to multiple end-of-line box processing stations.

### BRIEF DESCRIPTION OF THE DRAWINGS

FIG. 1 is a schematic layout of an exemplary packaging system for end-of-line box processing;

FIG. 2 is a schematic operational view of an exemplary end-of-line box processing operation illustrating an autonomous mobile robot autonomously moving toward an end-of-line box processing station;

FIG. 3 is a schematic operational view of the exemplary end-of-line box processing operation of FIG. 2 illustrating the autonomous mobile robot interacting with the end-of-line box processing station to receive a lid on a box aboard the autonomous mobile robot; and

FIG. 4 is a schematic flow chart of an exemplary end-of-line box processing method.

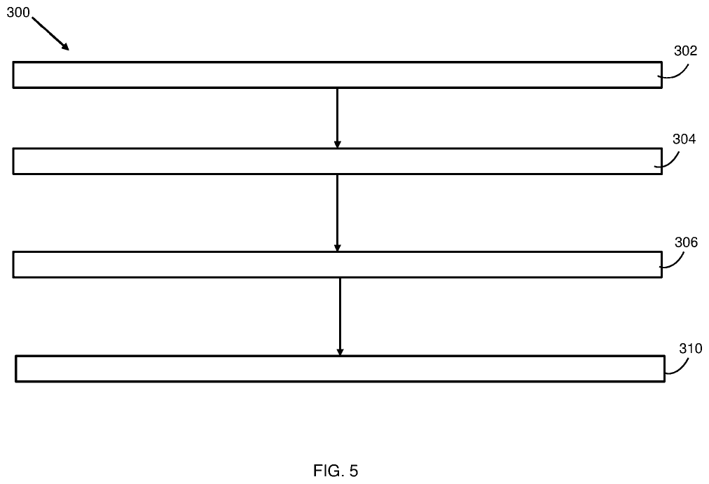

### DETAILED DESCRIPTION

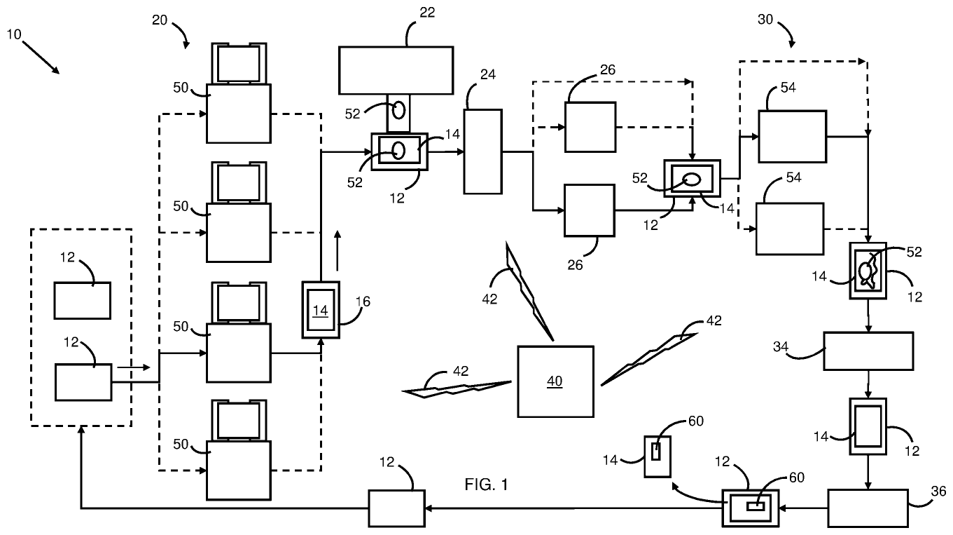

Turning now to the drawings, and initially to FIG. 1, a schematic representation of an exemplary automated packaging system 10 for end-of-line box processing is shown. The packaging system 10 includes multiple end-of-line box processing stations and one or more autonomous vehicles 12 for moving packaging containers 14 through selective ones of the end-of-line box processing stations. The end-of-line box processing stations are disposed so that an autonomous vehicle 12 has room to maneuver to bypass any end-of-line processing station. By using autonomous vehicles 12, the packaging system 10 minimizes or eliminates the need for a permanent continuous conveyor system in a fixed location, as is used in conventional packaging systems for end-of-line processing. Using autonomous transport vehicles 12 along with a control system that delivers packaging containers only to selective end-of-line box processing stations provides several advantages, including more flexibility for worker movement through and within the packaging system 10, and more flexibility in placement of end-of-line box processing stations within a packaging area, making reconfigurations easier.

The lack of a need for a fixed path also can speed up the packaging process by delivering containers only to the end-of-line box processing stations that are required and bypassing end-of-line box processing stations with packaging operations that are not needed, freeing up space at those end-of-line box processing stations for containers that need those end-of-line processing operations and avoiding delays for containers that do not need those end-of-line processing operations from needing to wait for a preceding container to clear an end-of-line box processing station. For example, instead of disposing multiple end-of-line box processing stations at fixed locations along a permanent conveyor system and conveying a packaging container from one end of the permanent conveyor system downstream through each and every end-of-line box processing station, the packaging system 10 described here provides standalone modular end-of-line box processing stations that may be disposed in any desired configuration, and a system controller 40 to direct an autonomous vehicle 12 to move a shipping container 14 through selective ones of the multiple end-of-line box processing stations while the packaging container 14 is onboard the autonomous vehicle 12. The modular nature of the end-of-line box processing stations also facilitates maintenance, and improves scalability, implementation, and process changes.

Throughout this description, the terms “container” and “box” are interchangeable and refer to any enclosure with strength suitable to withstand shipment, storage, and handling, and the required characteristics generally vary depending on the nature of the objects to be shipped within the enclosure. The most common shipping containers are cardboard boxes, such as a regular-slotted container (RSC) with flaps that fold down to close an open side of the container, and half-slotted containers (HSC, also referred to as shoebox-style containers) to which a separate lid is secured, typically with an adhesive, to close an open side of the container. Cardboard containers can have further different types, and different forms of construction. But the term “box” is not limited to cardboard boxes or any other material.

The end-of-line box processing stations include more than one of a box delivery station 20, sometimes referred to as a box-forming station or as a case-erecting station, for providing a box 14 to an autonomous vehicle 12; a product delivery station 22, sometimes referred to as a product-filling station or as a case-packing station for providing objects 52 to be shipped to the box 14; a scanning station 24 for detecting characteristics of the box 14 and the objects in the box 14; a box sizing station 26 for reducing a height dimension of the box 14 based on detected characteristics of the objects 25 in the box 14; a dunnage dispensing station 30 for providing dunnage material to the box 14; a lid-application station 34 for inwardly folding flaps of a box 14 over an open side of the box 14 and for applying a lid over the open side of the box 14; and a labeling station 36 for applying a shipping label to the box 14. Each end-of-line box processing stations may be designed to be a standalone modular end-of-line box processing station that can be positioned or moved to any suitable location within an end-of-line box processing area. Each end-of-line box processing station is spaced from other end-of-line box processing stations to facilitate movement between the end-of-line box processing stations.

Additionally, while some of these end-of-line box processing stations can be combined to provide all of the functions at one rather than two or more end-of-line box processing stations, or some of these end-of-line box processing stations can be split into multiple end-of-line box processing stations, the benefits of the packaging system 10 over previous fixed-conveyor systems is the ability to direct a box to bypass an end-of-line box processing station without waiting for a preceding box to exit the end-of-line box processing station. As an example, the labeling station 36 could be combined with the lid-application station 34 if a shipping label will always be added to the box 14 after the lid-application station 34 closes an open side of the box 14. Combining the box sizing station 26 and the dunnage dispensing station 30, however, would prevent boxes 14 from bypassing the box sizing station 26 to reach the dunnage dispensing station 30, which would slow the end-of-line processing if not every box 14 needed the processing operations at the box sizing station 26.

As a further example, if the packaging system 10 was processing boxes 14 both with and without flaps, the lid-application station 34 can be split into two different types, a lid-application station 34 with both flap-folding and lidding capabilities for boxes 14 with flaps, and a lidding station 34 without the flap-folding capabilities (or with the flap-folding features disabled) but with lidding capabilities for boxes 14 without flaps. In effect, the boxes 14 without flaps could bypass the flap-folding station.

While particular end-of-line box processing stations are described in connection with the embodiment of FIG. 1, the end-of-line box processing stations may be any suitable end-of-line box processing stations and may include, by way of further example, dunnage transferring stations, scanning systems, printing stations, labeling stations, height-reducing stations, non-conformant detection stations, non-conformant correction stations, other quality-assurance stations, and protective packaging systems and their accompanying consumables. This list is not exhaustive.

The packaging system 10 further includes a system controller 40 for controlling the coaction and interaction of the various components of the packaging system 10 and the end-of-line box processing stations 20, 22, 24, 26, 30, 34, and 36. One or more components of the packaging system 10 and end-of-line box processing stations may, however, be controlled manually or independently of each other, semi-automatically or automatically. The system controller 40 may be a programmable controller, suitably programmed to operate the packaging system 10 in a desired manner for a given application. The operations of the system controller 40 may be carried out by a single processor device or by separate processor devices for the various components of the packaging system 10, suitably interfaced to coordinate the operation of packaging system 10 as a whole.

For example, the system controller 40 can perform operations in response to executing software instructions stored by a non-transitory computer-readable medium, such as, for example, a non-transitory memory device including memory space within a single physical storage device or memory space spread across multiple physical storage devices. The software instructions can be stored locally within the system controller 40 or can be received remotely from another non-transitory computer-readable medium through a communication interface, such as, for example, a non-transitory computer-readable medium of a computing device disposed remote from the system controller 40 and in operable communication with the system controller 40 through a wireless protocol.

When executed, the software instructions stored in the memory or other storage component associated with the system controller 40 can cause the system controller 40 to perform one or more operations described herein. Additionally, or alternatively, hardwired circuitry may be used in place of or in combination with software instructions to perform one or more processes described herein. Thus, implementations described herein are not limited to any specific combination of hardware circuitry and software.

Thus, the system controller 40 can include a processor in the form of a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), any other suitable another type of processor, or combination thereof. The processor can be implemented in hardware, software, or a combination of hardware and software. In some embodiments, the system controller 40 can include a memory, such as, for example, a random-access memory (RAM), a read only memory (ROM), another type of dynamic or static storage device (e.g., a flash memory, a magnetic memory, an optical memory, etc.), or combination thereof that stores information or instructions for use by the system controller 40.

The components of the packaging system 10 may be in operable communication with one another directly or through the system controller 40 via a communication network 42, such as, for example, a wireless communication network. The components of the packaging system 10 may, however, be in operable communication via any suitable combination of one or more wired, wireless, or combined networks. For example, communication network 42 may include any one or more of the Internet, an intranet, a cloud network, a wide-area network (WAN), a local-area network (LAN), a wireless network, a digital subscriber line (DSL) network, a frame relay network, an asynchronous transfer mode (ATM) network, a virtual private network (VPN), any other suitable communication network, or a combination of communication networks.

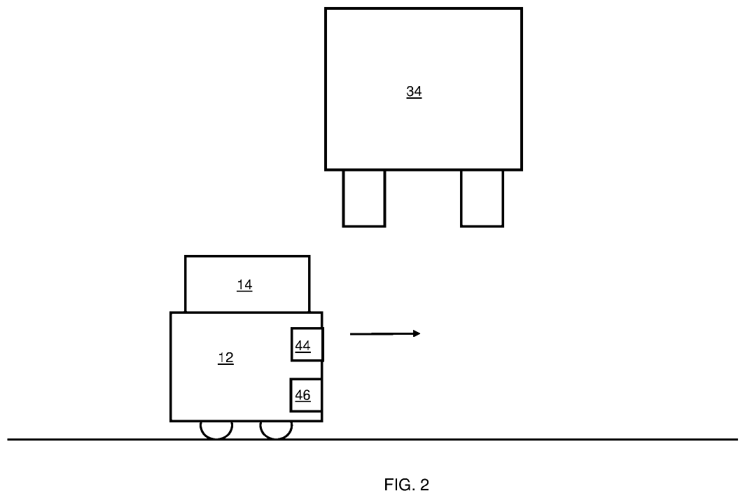

The at least one autonomous vehicle 12 of FIG. 1 may include an autonomous mobile robot (AMR) 12 for autonomously transporting the box 14 through the packaging system 10. Each AMR 12 includes an onboard navigation system for navigating through the packaging system 10 without a predetermined, fixed physical path. The onboard navigation system may include an inertial navigation system (INS) 44 (FIG. 2) and a navigation system 46 (FIG. 2) in operable communication with the system controller 40. The INS 44 and the navigation system 46 can include computing devices, motion sensors, rotation sensors, global positioning systems (GPSs), or any other suitable components, or combination thereof. The INS 44 allows the system controller 40 to determine a position, orientation, and velocity of the AMR 12 without reliance on external references, and the navigation system 46 allows the system controller 40 to selectively control each AMR 12 independently as the AMR 12 moves along a desired route as further described below. For example, the INS 44 can calculate the position, orientation, and velocity via dead reckoning and communicate the position data, orientation data, and velocity data to the system controller 40. The AMR 12 may, however, use any other suitable other localization or positioning systems, such as external positioning markers or signals at an end-of-line processing station.

Generally, each AMR 12 moves along a selected route between end-of-line processing stations independently of the system controller 22. In other words, the system controller 22 may instruct an AMR 12 on which end-of-line box processing stations should be visited without predefining the route the AMR 12 must take between two end-of-line box processing stations; in other words, without instructing the AMR 12 in real time when to make a turn, for example. This also means that the system controller 40 can instruct an AMR 12 to visit an end-of-line box processing station multiple times, if necessary, or to direct an AMR 12 to navigate between a set of end-of-line box processing stations that is only employed in very rare circumstances, something that would not be economically feasible for a fixed-route transportation system. Thus, the illustrated AMR 12 routes shown in FIG. 1 are but a few of the possible routes that an AMR 12 could take and the AMR 12 is not limited to the illustrated paths.

The packaging system 10 preferably includes multiple AMRs 12 to move multiple boxes 14 through the end-of-line processing stations automatically and substantially independently without continuous control by the system controller 40. The AMRs 12 may be provided as part of a supply of AMRs 12 at an upstream end of the end-of-line processing stations, or the AMRs 12 may queue at an end-of-line processing station until needed.

In the illustrated embodiment, a first end-of-line processing station is the box delivery station 20 which includes one or more supplies of boxes 14. The boxes 14 can be formed from flat cardboard that is cut, folded, and glued to form an open-topped box 14, or the boxes could be supplied from a supply of preformed boxes 14 folded flat that are opened and the bottom side of the box 14 closed at the box delivery station 20. Machines that open flat-folded boxes are commonly referred to as case erectors.

The illustrated box delivery station 20 includes multiple case erectors 50 to speed up the delivery of boxes 14 or to provide boxes 14 with different cross-sectional sizes (widths and depths) and heights. For example, the box delivery station 20 may include two case erectors 50 that erect boxes 14 with a smaller cross-sectional size, one of the two case erectors 50 erecting boxes 14 with a lower height and the other of the two case erectors 50 erecting boxes 14 with a taller height. The box delivery station 20 may further include two more case erectors 50 that erect boxes 14 with a larger cross-section size, with one of the two case erectors 50 erecting boxes 14 with a lower height and the other of the two case erectors 50 erecting boxes 14 with a taller height. This embodiment thus would provide four different size boxes 14—with a four different combinations of height, width, or depth dimensions.

A packer or other operator, such as at the product delivery station 22, can communicate via the communication network 42 to signal the box delivery station 22 that a box 14 is required. If the box delivery station 22 has provision for multiple different box sizes or types, the signal will include the size or type of box 14 that is required and an AMR 12 will navigate to the proper location to receive the needed box. Alternatively, AMRs 12 may be positioned at each of multiple locations within the box delivery station 22 to be ready to receive a particular size or type of box 14 at each such location.

The box delivery station 22 places a box 14 on the AMR 12 such that the AMR 12 supports the box 14 for movement with the AMR 12. The AMR 12 then travels from the box delivery station 22 to the product delivery station 24, where one or more objects 52 are placed in the box for shipment. The product delivery station 24 can automatically perform a product-filling operation, such as, for example, using a robot to pick an object 52 to be shipped from a supply thereof and placing the object 52 within the box 14 on the AMR 12. Alternatively, a packer can manually place the object 52 to be shipped into the box 14. The object 52 to be shipped may include multiple items. The box 14 either remains on the AMR 12 while the object 52 is placed in the box 14, or the box 14 is removed to the product delivery station 22 for filling and then returned to the AMR 12 after the object 52 is placed in the box 14.

The box 14 is tracked through the remaining selected end-of-line box processing stations, such as from either an identification of the AMR 12 that is transporting the box 14 or through an identification on the box 14 itself, such as through sensors at or around the end-of-line processing stations. The sensors may include a sensor that can detect a bar code or a radio-frequency identification device (RFID), for example, provided on the box 14 or the AMR 12.

From the product delivery station 24, the AMR 12 moves the box 14 through a quality scanning station 24, where a sensor, in communication with the system controller 22, determines the box dimensions, void volume, and height of the tallest item in the box 14, and communicates that information to the system controller 40. In other words, the sensor may be configured to identify characteristics of the box 14, contents of the box 14, or a combination thereof; conformance indicators of the box 14, the contents of the box 14, or a combination thereof; and dimensions of a void of the box 14 relative to the contents of the box 14.

The system controller 40 determines the end-of-line processing operations required for the box 14 and its contents, based at least in part on information from the sensor at the quality scanning station 24, and instructs the AMR 12 to move the box 14 through selected ones of the remaining end-of-line processing stations in a particular sequence, or simply instructs the AMR 12 to move the box 14 to a next selected one of the end-of-line processing stations.

In the illustrated embodiment, the next end-of-line processing station may be a box-sizing station 26, where a box size, specifically the height dimension, may be reduced as a function of the tallest object in the box 14. An exemplary box-sizing station 26 cuts down the corners of the box 14 to a height near the height of the tallest object in the box 14 and forms fold lines in the box 14 adjacent the height of the tallest object in the box 14. If no resizing is necessary, the AMR 12 may bypass the box-sizing station 26 and any AMRs in the box-sizing station 26, thereby changing the order of the sequence of boxes 14 being processed in the end-of-line processing stations.

Another end-of-line processing station is the dunnage dispensing station 30. The dunnage dispensing station 30 includes one or more protective packaging machines with a dunnage dispenser configured to dispense dunnage products to the box 14. The AMR 12 may be directed along a path to a particular dunnage dispenser or, if no dunnage is required, the AMR 12 may bypass the dunnage dispensing station 30 and any AMRs 12 in the dunnage dispensing station 30. Each dunnage dispenser dispenses protective packaging material, also referred to as dunnage, a dunnage pad, or a dunnage product, into the box 14 to protect the object 52 in the box 14 during shipment. Some exemplary protective packaging machines include void-fill systems, cushioning systems, and wrapping systems.

Void-fill systems can quickly and efficiently convert a stock material, such as paper, to fill empty spaces in a box 14 and protect the object 52 therein by reducing movement of the object 52 during shipping and potential damage sustained in transit. Cushioning systems typically convert a stock material, such as paper, into cushioning pads by folding and crumpling the paper to form a crush-resistant material so that the object 52 is protected from external shocks and vibrations during shipping as well as to prevent movement of object 52 as during shipping. Wrapping systems, for example, can create relatively flat pads or a mesh to securely wrap and protect an object 52 from shock and surface damage sustained during the shipping and handling process, line boxes 14, and provide separation when shipping multiple products. Insulation systems provide insulation for the objects 52 that require temperatures to be controlled during transport.

The packaging system 10 may include multiple dunnage dispensers 54 within the dunnage dispensing station 30, each of which is configured to deliver the same or a different type or quality of dunnage, such as void fill, cushioning, wrapping, or insulation, converted from a different stock material or to provide redundancy to accommodate higher volumes of dunnage dispensing (for example, by dispensing dunnage to multiple boxes at different dunnage dispensers 54 or using different basis weights of paper to different dunnage dispensers 54. If multiple types of dunnage are required, the AMR 12 could be directed to the dunnage dispensing station 30 multiple times. For example, a flat wrapping pad or an insulation pad can be placed in a box 14 before any object 52 to be shipped is placed in the box 14, and then the object 52 to be shipped is placed on top of the previously-inserted dunnage pad. Accordingly, in appropriate circumstances, an AMR 12 may be directed to the dunnage dispensing station 30 both before and after the product delivery station 22.

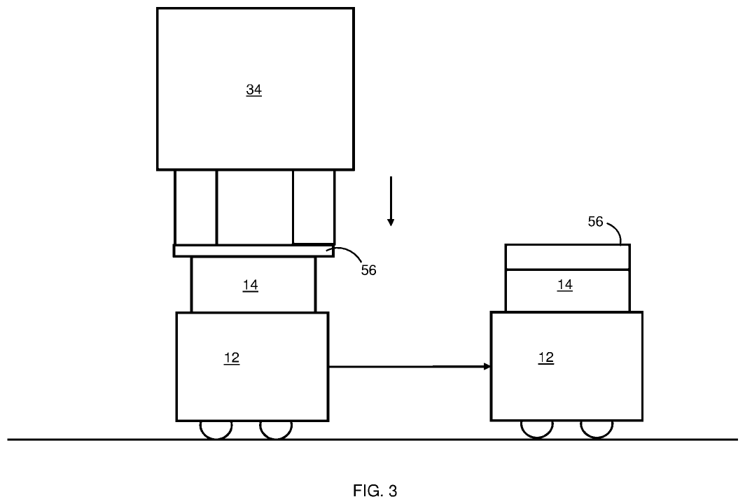

Once the box 14 is ready to be closed, the AMR 12 autonomously moves the box 14 to the lid application station 34. As part of the box-lidding operation, the lid application station 34 may include folding arms to inwardly fold upright flaps over the open top side of the box 14 to partially or fully close the open top side of the box 14. If the flaps do not fully close the open side of the box 14, the lid application station 34 can place a lid on the box 14 to close the open side of the box 14, as shown in FIG. 3, where the lid application station 34 is shown placing a lid 56 on a box 14 while the box 14 is supported onboard an AMR 12. If a box 14 does not have flaps that require folding before applying a lid, an alternative lid application station 34 can be provided for flap-less boxes 14.

After the lid 56 has been placed on the box 14, the AMR 12 can move the box 14 to the label application station 36 where a shipping label 60 can be applied to the box 14. In addition to or as an alternative to simply applying a shipping label 60 to the box 14, the label application station 36 can provide the shipping label 60 by printing directly onto the box 14 or printing the shipping label on a adhesive label after the adhesive label is attached to the box 14. Once the end-of-line processing process is complete, the box 14 is removed from the AMR 12. The AMR 12 is then routed back to the AMR supply until needed or directed directly to the box supply station 20 to receive another box 14.

The packaging system 10 may include additional sensors adjacent one or more end-of-line processing stations to check for nonconformant boxes. For example, as the AMR 12 moves away from the dunnage dispensing station 30 a sensor may check for a nonconformant condition, such as an improperly bent flap, a bulging side wall, or that the box 14 has shifted its position relative to the AMR 12, i.e., the sidewalls of the box 14 are no longer parallel to the sidewalls of the AMR 12. After determining that the box 14 is nonconformant, the system controller 40 can transmit an updated routing signal (not shown) to the AMR 12 that alters the previously-determined route of the AMR 12 such that the AMR 12 moves the box to an end-of-line processing station for remediation of the nonconformant condition. The nonconformant box 14 can be brought into conformance in any suitable manner, such as, for example, by an automated conforming station (not shown), or manually by an operator.

An exemplary end-of-line box processing method 300 using the packaging system 10 described above, will now be described with reference to FIG. 5. The method includes the steps of, at 302, providing a packaging system 10 having two or more end-of-line box processing stations and one or more autonomous vehicles 12 configured to move a box 14 between selected ones of the two or more end-of-line box processing stations. The end-of-line box processing stations include a product delivery station 22 where an object 52 to be shipped is placed in the box 14 for shipment. The method also includes the step, at 304, of loading a box 14 on an automated vehicle 12 to transport the box 14 to selective ones of the two or more end-of-line box processing stations. After the object 52 to be shipped is placed in the box 14, the method includes the step, at 306, of scanning the box 14 to detect characteristics of the box 14 and the object 52 in the box 14. Finally, the method includes the step, at 310, of directing the automated vehicle 12 to transport the box 14 from the product delivery station 22 to selective ones of the two or more end-of-line box processing stations, based, at least in part, on the detected characteristic information.

The loading step 304 may include erecting a box 14 and placing the box 14 on the autonomous vehicle 12, such as at the box delivery station 20. The scanning step 306 may include detecting one or more of a height dimension of the box, a width dimension of the box, a depth dimension of the box, a height dimension of one or more objects in the box, nonconformant characteristics of the box, and a void volume of the box. The scanning step 306 may be repeated after the box 14 is transported to at least one end-of-line box processing station. The directing step 310 may include instructions to bypass at least one end-of-line box processing station.

The method may further include the step of selectively causing, for example, via the system controller 40, at least one of the one or more end-of-line box processing stations to perform at least one of the one or more end-of-line box processing operations on the box 14. The box 14 may be onboard the autonomous vehicle 12 when the at least one of the one or more end-of-line box processing operations is performed on the box 14.

The method also may further include the step of detecting at least one characteristic of the box 14 and updating the route of the autonomous vehicle 12 based, at least in part, on the detected characteristic. The detecting step may include identifying at least one detected characteristic that indicates that the box 14 is nonconformant.

The method also may include the step of transporting the box 14 to multiple end-of-line box processing stations, where one or more processing steps are performed. Exemplary processing steps include providing dunnage to the box 14, forming flaps in the box 14, folding flaps inward over an open side of the box 14, applying and securing a lid over the open side of the box 14, applying a shipping label to the box 14, and/or printing information directly on the box 14 or a label pre-applied to the box 14.

In summary, a packaging system 10 for end-of-line box processing includes two or more end-of-line box processing stations 20, 22, 24, 26, 30, 34, and 36, each configured to perform one or more end-of-line processing operations, an autonomous vehicle 12, and a controller 40. The box processing stations 20, 22, 24, 26, 30, 34, and 36 include a supply of boxes 14, a product delivery station 22 where objects 52 to be shipped are placed in a box 14, and a sensor for detecting characteristics of the box 14 and the objects 52 in the box 14. The autonomous vehicle 12 is configured to autonomously transport the box 14 from the product delivery station 22 to selected ones of the two or more box processing stations 24, 26, 30, 34, and 36. The controller 40 is in communication with the sensor at the box scanning station 24 and the autonomous vehicle 12, and is configured to selectively direct the autonomous vehicle 12 to transport the box 14 from the product delivery station 22 to other selected ones of the two or more box processing stations 24, 26, 30, 34, and 36, based at least in part on information from the sensor at the scanning station 24.

Although the invention defined by the following claims has been shown and described with respect to a certain embodiment, equivalent alternations and modifications will occur to others skilled in the art upon reading and understanding this specification and the annexed drawings. In particular regard to the various functions performed by the above described integers (components, assemblies, devices, compositions, etc.), the terms (including a reference to a “means”) used to describe such integers are intended to correspond, unless otherwise indicated, to any integer which performs the specified function of the described integer (i.e., that is functionally equivalent), even though not structurally equivalent to the disclosed structure which performs the function in the herein illustrated exemplary embodiments of the invention.

1. A packaging system for end-of-line box processing, the system comprising:
two or more end-of-line box processing stations each configured to perform one or more end-of-line box processing operations, the end-of-line box processing stations including a supply of boxes, a product delivery station where objects to be shipped are placed in a box, and a sensor for detecting characteristics of the box and the objects in the box;
an autonomous vehicle configured to autonomously transport the box from the product delivery station to selected ones of the two or more end-of-line box processing stations; and
a controller in operable communication with the sensor and the autonomous vehicle, the controller configured to, based, at least in part, on information from the sensor, selectively direct the autonomous vehicle to autonomously transport the box from the product delivery station to other selected ones of the two or more end-of-line box processing stations.

2. The system claimed in claim 1, wherein the autonomous vehicle is an autonomous mobile robot.

3. The system claimed in claim 1, wherein the box is onboard the autonomous mobile robot when the at least one of the one or more end-of-line box processing operations is performed on the box.

4. The system claimed in claim 1, wherein the sensor is configured to detect at least one characteristic of the box, including at least one of a height dimension, a width dimension, and a depth dimension.

5. The system claimed in claim 4, wherein the at least one detected characteristic includes a nonconformant indicator of the box.

6. The system claimed in claim 1, wherein the controller is configured to direct the direct the autonomous vehicle to autonomously transport the box along a route that bypasses at least one of the two or more end-of-line box processing stations.

7. The system claimed in claim 1, wherein at least one of the two or more end-of-line box processing stations is automated.

8. The system claimed in claim 1, wherein the at least one of the two or more end-of-line box processing stations includes a first end-of-line box processing station and a second end-of-line box processing station disposed remote from the first end-of-line box processing station so that the automated vehicle can be directed to a selected one of the first end-of-line box processing station and the second end-of-line box processing station but not the other one of the first end-of-line box processing station and the second end-of-line box processing station.

9. The system claimed in claim 8, wherein the first end-of-line box processing station and the second end-of-line box processing station perform a same end-of-line box processing operation.

10. The system claimed in claim 8, wherein the first end-of-line box processing station and the second end-of-line box processing station perform a different end-of-line box processing operation.

11. An end-of-line box processing method, the method comprising the steps of:
providing a packaging system having two or more end-of-line box processing stations and one or more autonomous vehicles configured to move a container between selected ones of the two or more end-of-line box processing stations, the end-of-line box processing stations including a product delivery station where objects to be shipped are placed in the container for shipment;
loading a container on an automated vehicle to transport the container to selective ones of the two or more end-of-line box processing stations;
after the objects to be shipped are placed in the container, scanning the container to detect characteristics of the container and the objects in the container; and
directing the automated vehicle to transport the container on a route from the product delivery station to selective ones of the two or more end-of-line box processing stations based, at least in part, on the detected characteristic information.

12. The method claimed in claim 11, further comprising selectively causing at least one of the one or more end-of-line box processing stations to perform at least one of the one or more end-of-line box processing operations on the box.

13. The method claimed in claim 11, wherein the box is onboard the autonomous vehicle when the at least one of the one or more end-of-line box processing operations is performed on the box.

14. The method claimed in claim 11, further comprising detecting at least one characteristic of the box and updating the route based, at least in part, on the detected characteristic.

15. The method claimed in claim 11, wherein the detecting step includes identifying at least one detected characteristic that indicates that the box is nonconformant.

16. The method claimed in claim 11, wherein the directing step includes instructions to bypass at least one end-of-line box processing station.

17. The method claimed in claim 11, wherein the loading step includes erecting a box and placing the box on the autonomous vehicle.

18. The method claimed in claim 11, wherein the scanning step includes detecting one or more of a height dimension of the box, a width dimension of the box, a depth dimension of the box, a height dimension of one or more objects in the box, nonconformant characteristics of the box, and a void volume of the box.

19. The method claimed in claim 11, wherein the scanning step is repeated after the box is transported to at least one end-of-line box processing station.

20. The method claimed in claim 11, further comprising the step of transporting the box to multiple end-of-line box processing stations.
